(19) United States
(12) Patent Application Publication
(10) Pub. No.: US 2016/0356902 A1
(43) Pub. Date: Dec. 8, 2016

(54) Coupling Assembly

(71) Applicant: Kevin E. Swier, Corvallis, OR (US)

(72) Inventor: Kevin E. Swier, Corvallis, OR (US)

(73) Assignee: HEWLETT-PACKARD DEVELOPMENT COMPANY, L.P., Houston, TX (US)

(21) Appl. No.: 14/352,636

(22) PCT Filed: Nov. 22, 2011
(86) PCT No.: PCT/US11/61828

§ 371 Date: Jul. 29, 2014

(51) Int. Cl. G01V 1/16; G01V 1/18

(52) U.S. Cl. CPC G01V 1/166; G01V 1/18

(57) ABSTRACT

Example embodiments disclosed herein relate to a coupling assembly. The coupling assembly may include a projecting member or peg and a mounting member coupled to the projecting member or peg and configured to support a device (e.g., a seismic sensor) thereon. The coupling assembly may also include a bushing or sleeve adapted to connect to a mounting base and configured to include a cavity for receiving the projecting member or peg and an attachment assembly configured to releaseably secure the projecting member or peg within the cavity.

Seismic surveys are conducted to determine subsurface features such as minerals, water, oil, and gas. Such seismic surveys may utilize hundreds or even thousands of individual sensors placed in the ground and arrayed in a pattern over an area to be explored. Given these potentially large numbers as well as the various types of terrain that may be encountered, a need exists to be able to effectively deploy and subsequently remove these sensors to another survey location once the initial survey is completed.

### BRIEF DESCRIPTION OF THE DRAWINGS

The following detailed description references the drawings, wherein:

FIG. 1 is an example of a measurement assembly.

FIG. 2 is an exploded perspective view of an example of a coupling assembly.

FIG. 3 is an exemplary illustration of a peg or projecting member disposed in a cavity defined by a bushing or sleeve of the coupling assembly of FIG. 1.

FIG. 4 is a cross-sectional view taken along line 4-4 of FIG. 3.

FIG. 5 is an example of an alternative attachment assembly.

FIG. 6 is an example of another attachment assembly.

FIG. 7 is an additional example of another attachment assembly.

FIG. 8 is a further example of another attachment assembly.

### DETAILED DESCRIPTION

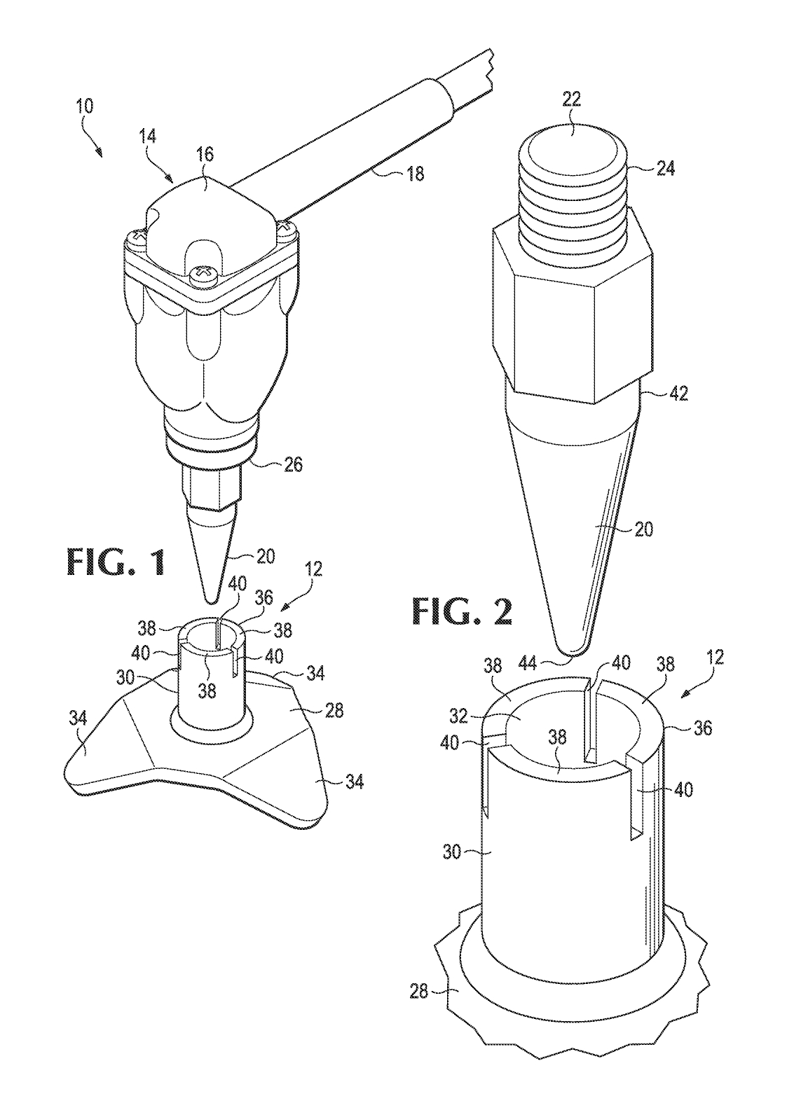

A new connecting assembly has been developed that allows a sensing unit (such as a seismic sensor), measurement assembly or other device to be quickly attached to a mounting base (such as a tripod) and subsequently removed without the use of any tools. An exemplary embodiment of such a measurement assembly 10 is shown in FIG. 1. As can be seen in FIG. 1, measurement assembly 10 includes a coupling assembly 12 to which a seismic sensor 14 is attached. Seismic sensor 14 is enclosed in a housing 16 to help protect it from external elements and is tethered to external electronics (not shown) via a cable 18.

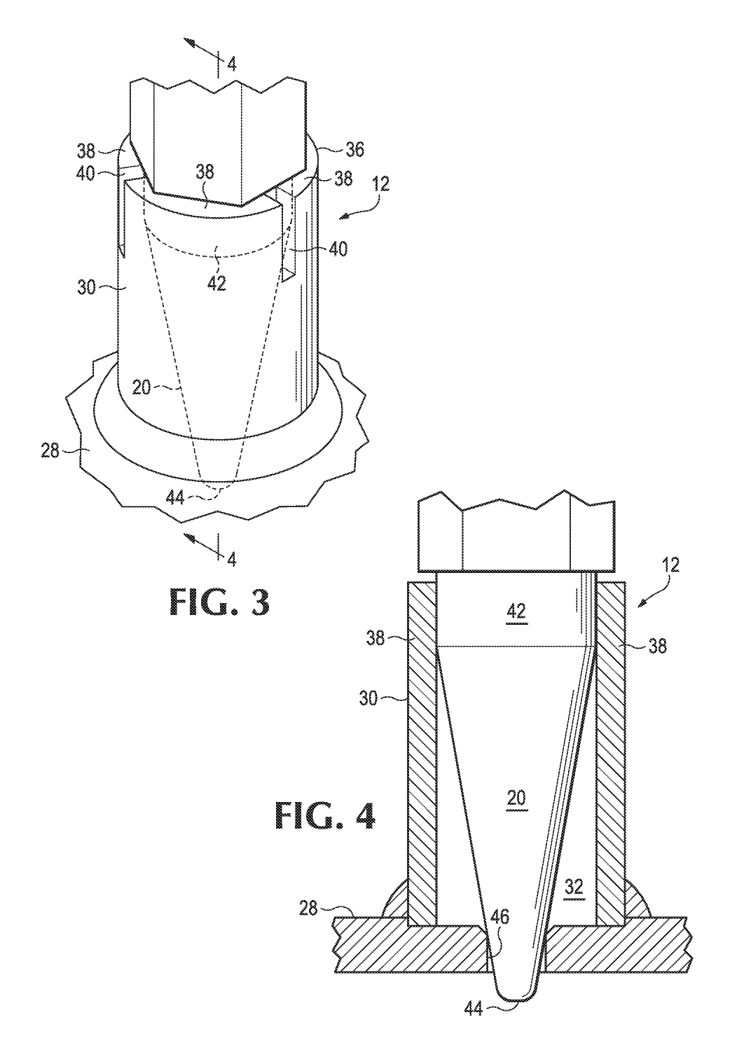

An exploded perspective view of an example of a coupling assembly 12 is shown in FIG. 2. As can be seen in FIG. 2, coupling assembly 12 includes a projecting member or peg 20 and a mounting member 22 connected thereto that is configured to support a device thereon such as seismic sensor 14. Projecting member or peg 20 may be in the general shape or form of a stake or spike and mounting member 22 may include a threaded stud 24 that is received in a threaded opening (not shown) located in the bottom 26 (see FIG. 1) of housing 16. Coupling assembly 12 additionally includes a mounting base 28 and a bushing or sleeve 30 coupled to mounting base 28. Bushing or sleeve 30 is configured to define a cavity 32 for receiving projecting member or peg 20 as shown, for example, in FIGS. 3 and 4. As can be seen in FIG. 1, mounting base 28 includes a plurality of legs 34 designed to contact a surface, such as the ground, thereby forming a tripod which provides a substantially level and rigid platform for the remainder of measurement assembly 10.

Coupling assembly 12 additionally includes an attachment assembly 36 that is configured to releaseably secure projecting member or peg 20 within cavity 32. As can be seen in FIGS. 1-3, attachment assembly 36 may include a plurality of flexible members or fingers 38 each bordered by a pair of slots 40 in bushing or sleeve 30. As can be seen in FIGS. 3 and 4, flexible members or fingers 38 grip a portion of the circumference of collar 42 when projecting member or peg 20 is inserted within cavity 32. The combination of flexible members or fingers 38 and collar 42 are designed to allow projecting member or peg 20 to be snapped or press-fit onto mounting base or tripod 28 without the use of tools.

As can be additionally seen in FIG. 4, tip 44 of projecting member or peg 20 is positioned within an opening 46 defined by mounting base 28 which helps stabilize projecting member or peg 20 within cavity 32. This, in turn, helps stabilize measurement assembly 10 which can help improve the accuracy of the data it records. Projecting member or peg 20 may be manually removed from cavity 32 (and thus its mounting base, not shown) without the use of tools by releasing the gripping action of flexible members or fingers 38 around the circumference of collar 42.

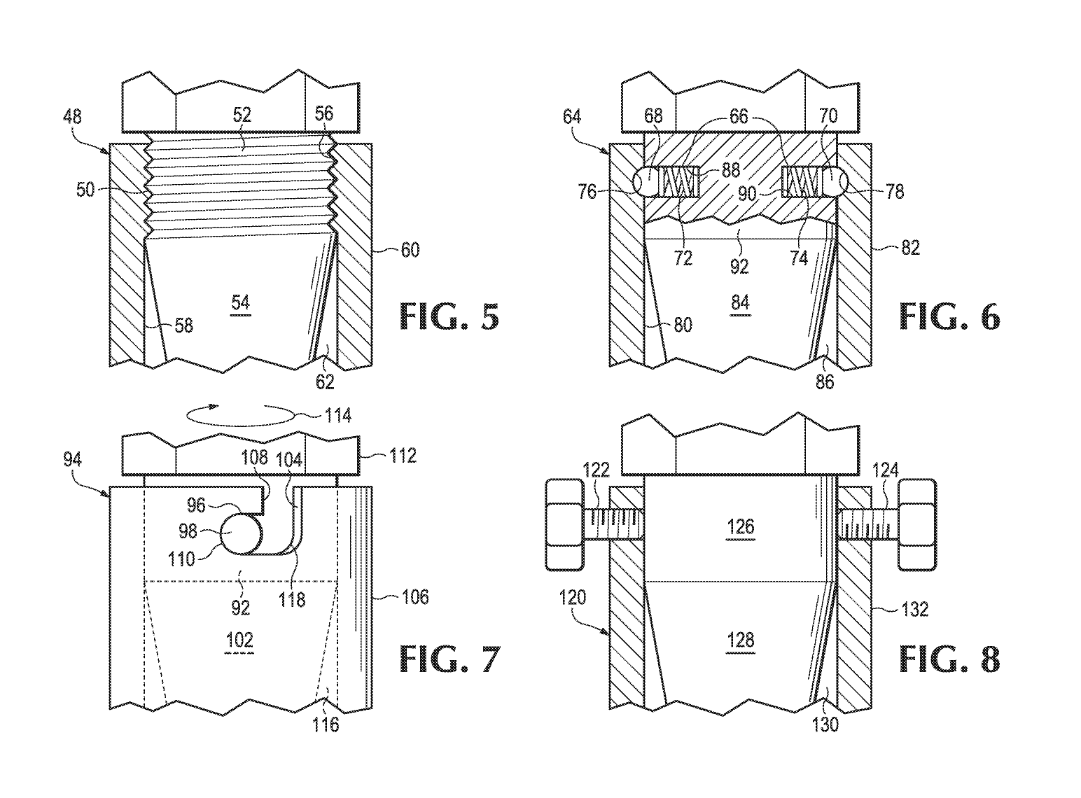

An example of an alternative attachment assembly 48 is shown in FIG. 5. As can be seen in FIG. 5, attachment assembly 48 includes a screw assembly 50 that has a plurality of first threads 52 on projecting member or peg 54 that screw into a plurality of second threads 56 on interior surface 58 of bushing or sleeve 60. This arrangement helps to secure projecting member or peg 54 within cavity 62 defined by bushing or sleeve 60. Projecting member or peg 54 may be manually removed from cavity 62 (and thus its mounting base, not shown) by unscrewing respective first and second threads 52 and 56.

Another example of an attachment assembly 64 is shown in FIG. 6. As can be seen in FIG. 6, attachment assembly 64 includes a detent assembly 66 having one or more balls 68 and 70 that are urged by respective biasing members 72 and 74 into recesses or depressions 76 and 78 in interior wall 80 of bushing or sleeve 82. This arrangement helps to secure projecting member or peg 84 within cavity 86 defined by bushing or sleeve 82. Biasing members 72 and 74 are housed in respective cavities 88 and 90 formed in collar 92 of projecting member or peg 84. Projecting member or peg 84 may be manually removed from cavity 86 (and thus its mounting base, not shown) by compressing biasing members 72 and 74 so as to remove balls 68 and 70 from respective recesses or depressions 76 and 78.

An additional example of another attachment assembly 94 is shown in FIG. 7. As can be seen in FIG. 7, attachment assembly 94 includes a bayonet assembly 96 that has a pin 98 on collar 100 of projecting member or peg 102 and a slot 104 in bushing or sleeve 106. Slot 104 is curved or bent such that pin 98 may be inserted at opening 108 and moved to the position generally indicated at 110 by, for example, manually rotating nut 112 in the direction of arrow 114. This arrangement helps to secure projecting member or peg 102 within cavity 116 defined by bushing or sleeve 106. Projecting member or peg 102 may be manually removed from cavity 116 (and thus its mounting base, not shown) by, for example, manually rotating nut 112 in a direction opposite that of arrow 114 so that pin 98 contacts side 118, at which point pin 98 can be removed from slot 104.

A further example of another attachment assembly 120 is shown in FIG. 8. As can be seen in FIG. 8, attachment assembly 120 includes a plurality of fasteners 122 and 124 that are configured to be manually positionable adjacent collar 126 of projecting member or peg 128. This arrangement helps to secure projecting member or peg 128 within cavity 130 defined by bushing or sleeve 132. Projecting member or peg 128 may be manually removed from cavity 130 (and thus its mounting base, not shown) by, for example, manually loosing fasteners 122 and 124 from a position adjacent collar 126.

The various components of measurement assembly 10 and coupling assembly 12 may be made from a variety of materials including, for example, metal, plastic, wood, silicon, and elastomers. These may be utilized in any variety of combinations depending upon various factors such as the intended environment of use, manufacturability, cost, weight, and durability.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. For example, although a seismic sensing unit has been illustrated above, it is to be understood that other types of sensing units or devices (e.g., GPS) may be used in accordance with the present invention. As another example, although various examples of attachment assemblies have been illustrated above, it is to be understood that other types of attachment assemblies are within the scope of the present invention. For example, a magnetic attachment assembly may be utilized or, alternatively, a hook and loop assembly. As a further example, although mounting member 22 has been illustrated in the form of a threaded stud 24, it is to be understood that other types of mounting members are within the scope of the present invention (e.g., magnetic, hook and loop, bayonet, etc.). The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A coupling assembly, comprising:
a peg;
a mounting member coupled to the peg and configured to support a device thereon;
a bushing adapted to connect to a mounting base and configured to include a cavity for receiving the peg; and
an attachment assembly configured to releaseably secure the peg within the cavity.

2. The coupling assembly of claim 1, wherein the attachment assembly includes a plurality of flexible members that grip the peg.

3. The coupling assembly of claim 1, wherein the peg is configured to include a plurality of first threads that screw into a plurality of second threads of the attachment assembly.

4. The coupling assembly of claim 1, wherein the attachment assembly includes a detent assembly.

5. The coupling assembly of claim 1, wherein the attachment assembly includes a bayonet assembly.

6. The coupling assembly of claim 1, wherein the attachment assembly includes a plurality of fasteners configured to be manually positionable adjacent the peg.

7. The coupling assembly of claim 1, wherein the mounting member is configured to include a threaded stud.

8. The coupling assembly of claim 1, wherein the peg includes a stake.

9. A measurement assembly, comprising:
a sensing unit;
a mounting base;
a projecting member coupled to the sensing unit;
a sleeve coupled to the mounting base and configured to define a cavity for receiving the projecting member; and
an attachment assembly configured to secure the projecting member within the cavity defined by the sleeve.

10. The measurement assembly of claim 9, wherein the mounting base includes a tripod.

11. The measurement assembly of claim 9, wherein the sensing unit includes a seismic sensor.

12. The measurement assembly of claim 9, wherein the attachment assembly includes a plurality of flexible fingers formed in the sleeve that grip the projecting member.

13. The measurement assembly of claim 9, wherein the attachment assembly includes a screw assembly.

14. The measurement assembly of claim 9, wherein the attachment assembly includes a detent assembly.

15. The measurement assembly of claim 9, wherein the attachment assembly includes a pin and slot assembly.

16. The measurement assembly of claim 9, wherein the attachment assembly includes a plurality of fasteners engagable with the projecting member.

17. The measurement assembly of claim 9, wherein the projecting member includes a spike.
